(19) United States
(12) Patent Application Publication
(10) Pub. No.: US 2021/0282136 A1
(43) Pub. Date: Sep. 9, 2021

(54) AUTOMATIC RADIO RESOURCE ALLOCATION PATTERN GENERATION FOR SPECTRUM EFFICIENCY IN COMPLEX COMMUNICATION SYSTEMS

(71) Applicant: Keysight Technologies, Inc., Santa Rosa, CA (US)

(72) Inventor: Dimas Lopez, Malaga (ES)

(21) Appl. No.: 17/106,331

(22) Filed: Nov. 30, 2020

(30) Foreign Application Priority Data
Mar. 9, 2020 (ES) P202030195

(51) Int. Cl. H04W 72/04; H04L 5/14; H04L 1/18; H04W 74/08; H04L 27/26

(52) U.S. Cl. CPC H04W 72/0446; H04L 5/14; H04L 27/2602; H04W 74/0833; H04L 1/1812

(57) ABSTRACT

A computer-implemented method is for generating a resource allocation pattern (RAP) of an orthogonal frequency division multiplexing (OFDM) signal transmitted between a base station including N cells and a mobile device, where N is one or more, the OFDM signal transmitted in either a frequency domain duplex (FDD) mode or a time domain duplex (TDD) mode. The method includes setting a time duration of the RAP, retrieving a TDD uplink/downlink (UL/DL) configuration setting indicative of successive OFDM slots including DL-only slots, UL-only slots and flexible slots, and processing the TDD UL/DL configuration to obtain an initial resource allocation pattern in which the TDD UL/DL configuration is repeated to match the set time duration of the RAP, and in which the flexible slots among the repeated TDD UL/DL configuration are set as DL slots or UL slots. For each of the N cells, the method further includes determining the set of UL resource allocations comprising downlink control information (DCI) and the offset to the corresponding UL signals for the RAP, and determining the set of DL allocations including DCI and Hybrid Automatic Repeat Request Acknowledgment (HARQ-ACK) resources for the RAP.

### CROSS-REFERENCE TO RELATED APPLICATIONS

The present application claims priority under 35 U.S.C. § 119(e) to Spanish Patent Application No. P20203019562, filed on Mar. 9, 2020, and naming Dimas Lopez as inventor. The entire disclosure of Spanish Patent Application No. P20203019562 is hereby specifically incorporated by reference in its entirety.

### BACKGROUND

In complex radio communication systems, system level management of radio resources (typically referred to as Radio Resource Management or RRM) is desirable to most efficiently utilize available radio-frequency spectrum resources and network infrastructure. For example, in the case of recent generation cellular networks, resource management protocols may dynamically implement schemes to efficiently maximize multi-user and multi-cell capacities.

Current wireless standards have a very high degree of flexibility and granularity when it comes to performing radio resource allocations to connected devices, both in time and in frequency. This flexibility comes at a price when designing base stations that tackle multiple physical channels and data connections at the same time. As examples, there are periodic allocations that need to be guaranteed, physical channel collisions to avoid, and resource availability checks to perform. To deal with the resulting level of complexity, instead of dynamic resource allocations, which would require a lot of computer processing resources, semi-static, periodic allocation patterns can be used that take all this into account.

Fourth Generation (4G) Long-Term Evolution (LTE) and especially Fifth Generation New Radio (5GNR) are good examples of this flexibility and complexity. In these radio access technology standards, which were developed by the Third Generation Partnership Project (3GPP), the resource allocations are a mixture of semi-static parameters setup by a Radio Resource Control (RRC) layer, and dynamic allocations via Downlink Control Information (DCI).

### SUMMARY

According to an aspect of the inventive concepts, a computer-implemented method is provided for generating a resource allocation pattern (RAP) of an orthogonal frequency division multiplexing (OFDM) signal transmitted between a base station comprised of N cells and a mobile device, where N is one or more, the OFDM signal transmitted in either a frequency domain duplex (FDD) mode or a time domain duplex (TDD) mode. The method includes setting a time duration of the RAP, retrieving a TDD uplink/downlink (UL/DL) configuration setting indicative of successive OFDM slots including DL-only slots, UL-only slots and flexible slots, and processing the TDD UL/DL configuration to obtain an initial resource allocation pattern in which the TDD UL/DL configuration is repeated to match the set time duration of the RAP, and in which the flexible slots among the repeated TDD UL/DL configuration are set as DL slots or UL slots. For each of the plural cells, the method further includes determining a set of UL resource allocations comprising downlink control information (DCI) and an offset to corresponding UL signals for the RAP, and determining a set of DL allocations including DCI and Hybrid Automatic Repeat Request Acknowledgment (HARQ-ACK) resources for the RAP.

According to another aspect of the inventive concepts, a non-transitory computer-readable storage medium including a computer program is provided. The computer program when executed by a computer causes the computer to be responsive to user variable input settings to generate a resource allocation pattern (RAP) of an orthogonal frequency division multiplexing (OFDM) signal transmitted between a base station device comprised of N cells and a mobile device, wherein N is one or more, the OFDM signal transmitted in either a frequency domain duplex (FDD) mode or a time domain duplex (TDD) mode.

According to another aspect of the inventive concepts, a Fifth Generation (5G) New Radio (NR) network emulator is provided that includes N cells configured to communicate with a mobile device using orthogonal frequency division multiplexing (OFDM) signal transmission, where N is one or more, the OFDM signal transmitted in either a frequency domain duplex (FDD) mode or a time domain duplex (TDD) mode, and a resource allocation pattern (RAP) generator configured to generate a resource allocation pattern of signal slots of the orthogonal frequency division multiplexing (OFDM) signal for the plurality of cells with reference to radio resource control (RRC) settings.

### BRIEF DESCRIPTION OF THE DRAWINGS

The above and other aspects and features of the inventive concepts will become readily apparent from the detailed description that follows, with reference to the accompanying drawings, in which:

FIG. 1 is a schematic diagram of a Fifth Generation New Radio (5GNR) network emulation platform according to an embodiment of the inventive concepts;

FIGS. 2 and 3 are diagrams for reference in explaining the relationships between a symbol, a slot, a subframe, and a frame in 5GNR networks;

FIG. 4 a schematic diagram of a wireless (radio) communications system in accordance with embodiments of the inventive concepts;

FIG. 5 is a flow chart for reference in describing a resource allocation pattern (RAP) generator in accordance with embodiments of the inventive concepts; and

FIGS. 6, 7 and 8 are orthogonal frequency division multiplex (OFDM) slot diagrams for reference in describing examples of operational phases carried out by a RAP generator according to embodiments of the inventive concepts.

### DETAILED DESCRIPTION

For purposes of description, the embodiments presented below are directed to examples in which the complex communication system being managed is governed by 3GPP 5GNR standards (hereinbelow “5GNR”). However, the inventive concepts are not limited to 5GNR. For example, the inventive concepts may be applied to 4G LTE and to future generation standards.

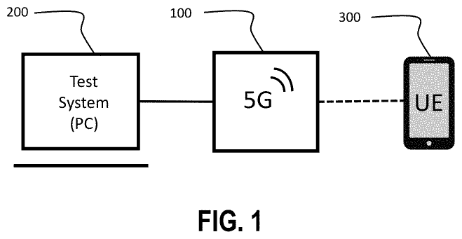

Also for purposes of description, some embodiments are described in the context of a 5GNR network emulator. In this respect, attention is directed to the schematic diagram of a test setup illustrated in FIG. 1. Referring to FIG. 1, the test configuration includes a 5G network emulator 100, a test system 200 and user equipment (UE) 300. The UE 300 may be a wireless or mobile device such as a cellular telephone or mobile computing device. In operation, the test system 200 (which may be implemented on a general-purpose computer (PC)) uses a toolset to create test and configuration elements. Power levels for synchronization and reference signals, beamforming, and resource blocks used for transmitting and receiving control information and data may be specified. Software may be used to evaluate data throughput to and from user equipment (UE) 300 over the 5G network emulator 100.

One example of a 5G network emulator to which the inventive concepts may be applied is the E7515B UXM 5G Wireless Test Platform (“UXM 5G”) supplied by Keysight Technologies Inc. The LAM 5G enables users to establish a 5G call with a device under test (DUT) in different 5GNR deployment modes (non-stand alone (NSA) and stand-alone (SA)) and frequency bands (Frequency Range 1 and Frequency Range 2) and perform signaling, test in terms of device radio frequency (RF) characteristics, protocol compliance and functional key performance indicators.

Current configurations trust the end user of the test system 200 and/or 5G network emulator 100 will have the necessary technology understanding to build a sophisticated semi-static pattern of resource allocations that considers all the constraints and rules of the 3GPP specification. In the real world, however, not all end users have this level of technology understanding. Indeed, creating an optimal resource allocation is far from trivial even for the most experienced 3GPP engineers. In addition, coming up with a satisfactory pattern takes time, and such pattern will only work well for that combination of radio resource control (RRC) parameters for which the pattern was designed. Often, changing a single RRC parameter makes the pattern fall apart.

In practice, operators typically rely on scripts that are written ad hoc and consider a fixed and known RRC configuration, and that are sometimes dependent on an operator's test environments and devices. However, there are multiple drawbacks to using scripts. First and foremost, the scripts need to be maintained. Every time systems change part of their Application Program Interface (API) or their behavior, someone needs to align the scripts to make them work again as intended. This leads to the maintaining multiple branches of the scripts for each system change or version of end-product. A second problem is that these scripts have very limited flexibility and will work only for certain RRC configurations. If an operator ever wants to change a critical RRC setting that breaks existing scripts, new scripts will need to be written. It is an understatement to say that this can be a tedious and time-consuming process. This is especially problematic when the person writing the scripts has limited technological understanding of product specifications and limitations.

The embodiments herein address these and other limitations by providing full throughput allocation of 5GNR. Regardless of the combination of parameters selected, the embodiments generate a resource allocation pattern that may maximize allocated radio resources for data throughput, while at the same time complying with 3GPP rules and system limitations.

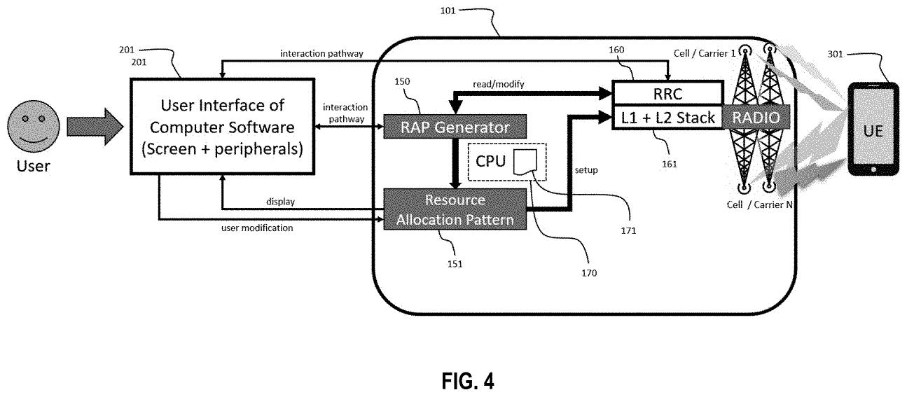

Prior to describing the embodiments in detail (beginning with FIG. 4), the description next presents a review of some of the relevant characteristics and rules of 5GNR. To assist in the description, the relevant characteristics and rules are identified by rule number, i.e., Rule 1, Rule 2, and so on. Reference will be made back to these rules in the description of the embodiments that follows. It will be understood that different rules may apply in the case where the inventive concepts are applied to standards other than those of 5GNR.

Rule 1: There are two operation modes in 5GNR, namely, Frequency Domain Duplex (FDD) and Time Domain Duplex (TDD). In FDD mode, both uplink and downlink can transmit at the same time at different spectrum frequencies. In contrast, TDD mode is at least partially characterized by both uplink (UL) and downlink (DL) using the same spectrum frequencies but at different times. In TDD mode, if a modulated symbol is transmitted from the network to the mobile device (DL), the device will not transmit anything to the network (UL) during that symbol nor to the symbol that immediately follows such symbol. This second symbol is called the guard symbol. Similarly, UL symbols cannot be used for DL. On the other hand, in FDD mode both uplink and downlink can transmit at the same time at different spectrum frequencies. FDD mode does not have the restrictions of TDD and any symbol can be simultaneously used in DL and UL.

Rule 2: In TDD mode, RRC controls whether a symbol during a configurable period can be used just for DL, just for UL or whether this can be flexibly/dynamically allocated by the radio resource allocator. This RRC setting is referred to here as the TDD DL/UL configuration. That is, the TDD DL/UL configuration determines which slots are configured as downlink, which are uplink, and which are special slots.

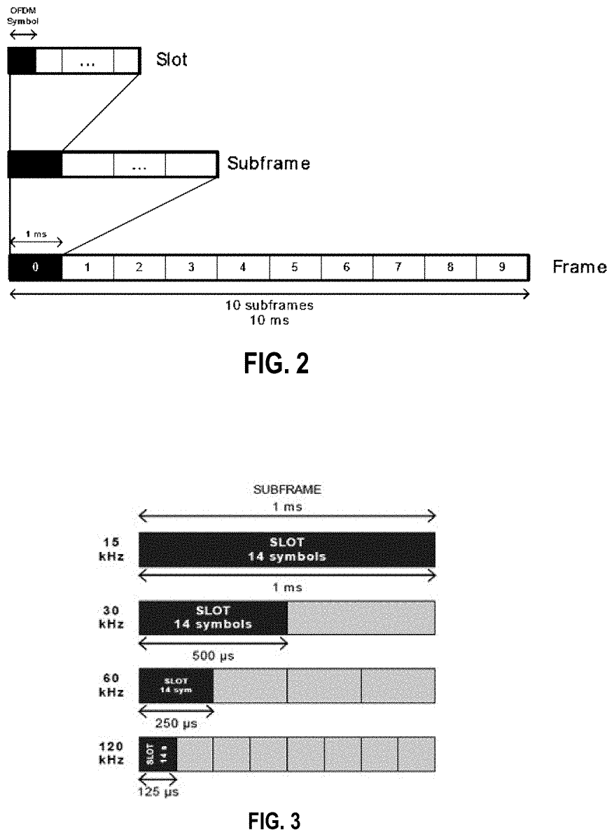

Rule 3: This rule relates to FIGS. 2 and 3 which are diagrams for reference in explaining the relationships between a symbol, a slot, a subframe, and a frame in 5GNR. Referring to FIG. 3, each 5GNR frame lasts for 10 ms and is comprised on 10 subframes of 1 ms each. Each 5GNR slot is comprised of fourteen (14) OFDM symbols if extended Cyclic Prefix (CP) is not enabled. The duration of a slot and the number of slots per subframe depend on the configured subcarrier spacing (SCS). This is illustrated in FIG. 4 in which a subframe contains 1 slot of 1 ms for 15 kHz SCS, 2 slots of 500 μs each for 30 kHz SCS, 4 slots of 250 μs each for 60 kHz SCS, or 8 slots of 125μs each for 120 kHz SCS.

Rule 4: DL and UL data transmissions are dynamically scheduled by the network. These transmissions are indicated via downlink control information (DCI) that are sent by the network. Among other things, these DCIs indicate whether a DL or a UL transmission is scheduled, the offset (in full 5GNR slots) between the DCI and the corresponding DL/UL transmission slot and its allocated symbols (starting symbol+number of symbols) within the slot. The offset and the symbol allocation are indicated in the DCI via an index to a table semi-statically configured by RRC, referred to as the DL or the UL Time Domain Resource Allocation (TDRA) lists.

Rule 5: In the meantime, each DL transmission is followed by a HARQ-ACK transmission sent by the mobile device indicating whether such transmission was correctly received/decoded by the mobile device. The offset between the DL transmission and such HARQ-ACK transmission is also indicated in the DCI via an index to a lookup table setup by RRC. This may be referred to as a dl-DataToUL-ACK list.

Rule 6: Symbols occupied by network broadcast transmissions (synchronization signal block (SSB)) cannot be used by the mobile device to transmit anything to the network. Likewise, symbols reserved for Physical Random Access Channels (PRACH) (potentially transmitted by the mobile device to access the network resources) should not be used for network-originated transmissions.

Rule 7: In addition, once a DL/UL allocation has been scheduled via DCI to take place on specific symbols, no future DCI can schedule a DL/UL transmission that takes place before such DL/UL allocation. Similarly, if a DL transmission triggers HARQ-ACK to take place on specific symbols, no future DCI can schedule a DL transmission whose HARQ-ACK happens before such HARQ-ACK that was scheduled earlier. Another relevant rule is that, once the DCI for UL allocation is sent, the network should not send a DCI for DL that makes HARQ-ACK overlap in symbols with the UL allocation that was scheduled by an earlier DCI. Reference can be made to 38.213 and 38.214 3GPP specification documents for more information on these rules.

Attention is now directed to FIG. 4 which is a schematic diagram of a wireless (radio) communications system in accordance with embodiments of the inventive concepts.

As shown, the system includes a user interface 201, a base station 101, and user equipment (UE) 301. The user equipment (UE) 301 may be a wireless or mobile device such as a cellular telephone or mobile computer device.

The base station 101 may be either the base station of an actual 5G network or a 5GNR network emulator. In either case, the base station 101 is configured to establish radio communication with user equipment (UE) 301 over a plurality of cells (or carriers).

In the case where the base station 101 is a network emulator, the base station 101 may, for example, be implemented at least in part by the earlier described E7515B LAM 5G Wireless Test Platform supplied by Keysight Technologies Inc.

Still referring to FIG. 4, the base station 101 is loaded with software that functions as a resource allocation pattern (RAP) generator 150. As is represented in FIG. 4, the software is a computer program that may be stored in a memory 171 and executed by a central processing unit (CPU) 170 having access to the memory 171. Here, the memory 171 is one or more non-transitory computer-readable storage media, examples of which include hard disc memory, solid state memory, non-volatile memory cards, static random access memory (SRAM), and dynamic random access memory (DRAM), Excluded from non-transitory computer-readable storage media are transitory signals propagating through the air, cables, wires, waveguides, and so on. As will be explained in detail below, the RAP generator 150 is responsive to the user interface 201 and settings of the RRC 160 to automatically generate a resource allocation pattern 151 for each of N cells. In some embodiments, the number of cells N is one or more. In some other embodiments, the number a cells N is at least two. The software maximizes the radio resources allocation for a set of RRC parameters and changes the output if the RRC parameters change. Preferably the software interface is based on the 3GPP RRC interface and basic DCI fields from the 3GPP 38.212 specification document. This preference allows the software to be independent of the application or product that currently uses it and it would not need to be updated every time the interfaces of the implementing device changes. However, the inventive concepts are not limited in this fashion.

The user interface 201 may be a separate computer such as a general-purpose personal computer (PC) including a processor, operating system, display screen and peripherals. The user interface 201 may include a toolset in the form of software for operationally interfacing with the 5GNR base station 101. In the context of the inventive concepts, this includes interaction with RRC settings and the RAP generator 150. In addition, the user interface 201 may be configured to display the resource allocation pattern 151 and may include a mechanism to allow the user to modify the resource allocation pattern 151.

In the meantime, as those skilled in the art will understand, the resource allocation pattern 151 sets up the behavior of the Layer 1 (L1) and Layer 2 (L2) protocol stacks of the 5GNR network (or emulated network). Here, Layer 1 is the physical (PHY) layer, and the Layer 2 protocol layer includes a media access control (MAC) sublayer, a radio link control (RLC) sublayer, and a packet data convergence protocol (PDCP) sublayer. A Layer 3 of the protocol stack is constituted by the RRC.

In the embodiment of FIG. 4, the user interface 201 and base station 101 are separate devices. However, in other embodiments of the inventive concepts, the functionality of both devices is integrated into a single computing and emulating unit operated either locally or remotely by a user. For example, in the case where the base station 101 is a network emulator, the user interface 201 may be integrated with the emulator device.

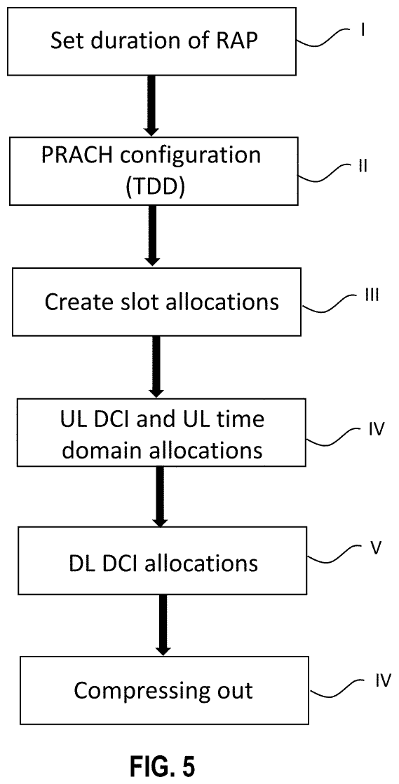

The operations of the RAP generator 150 will now be described. For purposes of explanation only, the operations will be described in terms of operational phases, i.e., Phase I through Phase VI as shown in FIG. 5. It is emphasized, however, that the inventive concepts are not limited in this fashion. For example, two or more phases may be functionally combined, and the phases may not necessarily need to be carried out in the ordered described.

Referring to FIG. 5, in Phase I the RAP generator 150 automatically sets a duration of the resource allocation pattern. Preferably, the duration is set to make sure that all iterations of the resource allocation pattern will result in the same behavior regardless of the RRC configuration present on each cell. The RAP generator may accomplish this by computation of the Least Common Multiple (LCM) of a synchronization signal block (SSB) periodicity across all serving cells and a period of the successive OFDM slots indicated by the TDD UL/DL configuration across all serving cells.

As indicated in FIG. 5, Phase II of the RAP generator 150 relates to PRACH in the case of the TDD mode. Specifically, for each cell configured with PRACH, the RAP generator 150 automatically determines the PRACH configuration index (which is an RRC setting value) that minimizes the number of PRACH occasions on slots flagged as ‘flexible’ by TDD DL/UL configuration settings. In order to achieve this, a mapping of SSB with PRACH is determined by the RAP generator 150 to make sure only valid PRACH occasions are considered. PRACH periodicity is selected by the RAP generator 150 so the duration determined in Phase 1 is a multiple thereof.

Still referring to FIG. 5, in Phase III the RAP generator 150 automatically creates the allocation for each of the slots of the pattern for each cell. The operations for this phase differ for the FDD mode and the TDD mode. That is, in the case of FDD cells, the RAP generator 150 flags all slots to convey DL and UL allocations.

On the other hand, in the case of TDD cells, the RAP generator 150 follows the TDD DL/UL configuration to flag the ‘DL-only’ slots in this configuration to be used for DL and the ‘UL-only’ slots to be used for UL. The RAP generator 150 sets up a number of flexible slots as DL and the remaining as UL to correspond to an input parameter (or ratio) R_{DL/UL}. Further, flexible slots containing PRACH occasions may always set up by the RAP generator 150 for UL to avoid overlap of DL with PRACH (see Rule 6 above).

After all slots have been flagged, a guard symbol is reserved in the last symbol of each slot that has been flagged for DL that is immediately followed by a slot that has been flagged for UL to comply with the Rule 1 above.

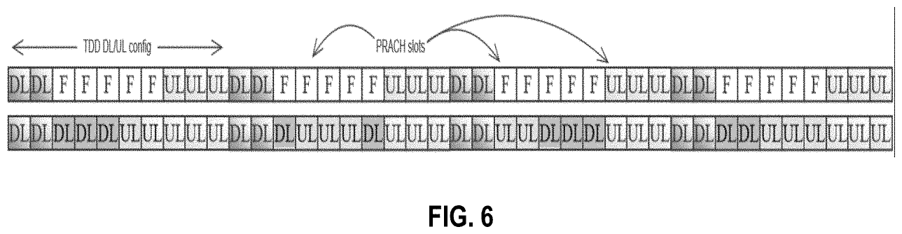

Attention is directed to FIG. 6 for an example of Phase III of the RAP generator 150 in the case of TDD cells. The illustrated example is directed to a case of 30 kHz SCS, a TDD DL/UL configuration of 5 ms (10 slots), and an R_{DL/UL}=50%. The upper row of the figure represents the TDD DL/UL configuration of the resource allocation pattern prior to Phase III, and the lower row represents the resource allocation pattern after Phase III. DL-only slots before Phase III remain DL slots after Phase III, and UL-only slots before Phase III remain UL slots after Phase III. On the other hand, the required R_{DL/UL} ratio is achieved considering all flexible regions that fit within the duration of the resource allocation pattern that was determined during Phase I (2 frames, or 4 periods of given the TDD DL/UL pattern), with the proviso that PRACH slots are used for UL (i.e. DL uses flexible slots that do not convey PRACH).

Referring back to FIG. 5, Phase IV of the RAP generator 150 relates to UL DCI allocation and UL time-domain symbol allocation. This phase is performed independently per cell and consists of determining the slot in which the DCI that allocates each UL is being sent (i.e. deciding an offset “k₂” between the UL DCI and its corresponding UL data transmission) and the symbol allocation for the UL data transmission. Here again, the RAP generator 150 operates differently in the TDD and FDD modes. In both cases, however, the RAP generator 150 first clears the UL TDRA list.

In the case of FDD, the offset k₂ is set to 4 and all 14 symbols of every UL slot are allocated. As a result, the UL TDRA list contains a single entry with this combination of k₂ equal to 4, start symbol 0 and number of symbols 14.

In the case of TDD mode, the procedure is more complex since DL/UL overlaps need to be checked. To make sure previously described Rule 7 is not violated, the RAP generator 150 allocates the symbols and DCI for the rightmost UL slot in the pattern determined during Phase III. In addition, the RAP generator 150 determines how many UL symbols to allocate, based on the TDD DL/UL configuration and the SSB allocation (see Rule 6). If all symbols in the slot are UL (or a combination of UL+flexible) and there are no SSB symbols, all 14 symbols will be mapped to UL. Symbols that are configured by TDD DL/UL configuration to be DL (plus the required guard symbol), SSB symbols or symbols setup by the RAP generator 150 to convey a DCI and its guard symbol are not mapped to UL (see Rule 1).

The RAP generator 150 then selects an earlier slot that has been flagged for DL during Phase III. If that is not possible, it selects a flexible (F) slot that has been setup for UL but using the lowest possible k₂ value that is larger or equal than 1. When the latter happens, such slot is flagged to convey a DCI (because sending the DCI in there would remove the symbols for the DCI plus a guard symbol, thus reducing available symbols for UL in such slot).

Every time a new combination of k₂ and start/length symbol allocation is considered, it is added to the UL TDRA list. The list may, for example, hold up to 16 entries. Once the list is full, only combinations already in the list can be selected in this phase for this cell. If no combination is possible, the UL slot is dropped, and no UL transmission will be performed in such slot.

The RAP generator 150 continues, from rightmost UL slot to leftmost UL slot. Because of the pattern being periodic, the RAP generator may wrap around to check the feasibility of sending UL DCIs in slots that have already been setup with all 14 symbols for UL (rightmost UL slots). If required, those slots are modified and have their symbol allocation reduced to convey the UL DCI symbols.

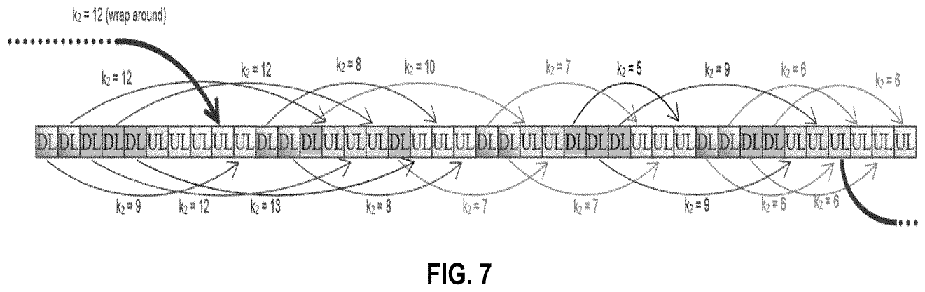

FIG. 7 is a slot diagram for reference in describing Phase IV of the RAP generator 150. In this example, the RAP generator 150 started from the rightmost UL slot and found a non-UL slot at 6 slots distance, so it added this entry to the UL TDRA (k₂=6, start symbol 0, 14 symbols in total). The RAP generator 150 does the same for the next 3 UL slots (reusing the same entry in the UL TDRA). Next UL slot needs a k₂ of 9, so a second entry is added to the UL TDRA in such case. The RAP generator 150 goes on until it computes that it needs to wrap around the pattern to find a slot in which the TDD DL/UL configuration would allow a DCI to be sent (a flexible slot in this case). However, such slot has all symbols allocated to UL already. The RAP generator 150 checks the DCI resources (Search Space and Control Resource Set (CORESET) RRC settings) to know the number of symbols that are required and modifies the UL allocation in such slot so that a DCI (plus the guard symbol) can be transmitted by the network in such slot. If the required UL TDRA entry already exists, it uses it. If not, it tries to add it. In case the list is already full the already allocated UL cannot be modified and current UL slot is dropped (not allocated) if there are no other alternatives.

Referring again to FIG. 5, Phase V of the RAP generator 150 determines the DL DCI allocation, the symbol start and number of symbols of the DL data transmission and the resources for the HARQ-ACK allocation. Here, the distance between the DL DCI and the DL data transmission will always be 0 slots by design (k₀=0), but the distance between the DL data transmission and the corresponding HARQ-ACK (k₁) will change depending on the circumstances. There is no differentiation between TDD and FDD in this phase.

First, the RAP generator 150 clears the DL TDRA and the dl-DataToUL-ACK lists (see Rule 4). Contrary to Phase IV, DL slots are allocated for all cells from left (i.e. first) to right (last), within the pattern duration. In other words, the RAP generator loops through each slot in the pattern. If a DL slot is found for one or more carriers, the corresponding DL DCI, DL symbols and HARQ-ACK resources are allocated starting from the cell with lowest Serving Cell Index (RRC setting).

For each DL slot that is being allocated, all symbols that will not be used for the DCI transmission (based on Search Space and CORESET RRC settings), and that are allowed by the TDD DL/UL configuration in the case of TDD cells, are allocated for DL data. The DL TDRA list may typically include fewer entries than the UL TDRA list given k₀ will always be set to 0 and the allocated symbols for data will typically be starting on symbol 1 and ending on symbol 13 (13 in total) (except for cases of flexible slots with a few symbols set for UL in the TDD DL/UL configuration or cases in which HARQ-ACK resources need to be allocated (as explained later)).

Regarding HARQ-ACK resources, they are allocated on a cell designated as PUCCH cell (RRC setting). This cell is usually the one defined as Primary Cell in RRC configuration. The value of k₁ is selected to favor slots that have already been selected to carry HARQ-ACK resources (so these can be reused) and then slots that Phase III flagged for UL on any cell (because the HARQ-ACK will be transmitted on the UL slot of that cell in such case). If none of the slots cover any these two criteria (which could happen when PUCCH cell is a TDD cell), flexible slots (potentially selected for DL in PUCCH cell) will be selected to carry HARQ-ACK. If here are multiple candidates for this, the RAP generator 150 selects the candidate addressed with the highest possible k₁ value. This might result in a modification of the allocable DL symbols on such slot, but a high k₁ value also means this slot might be reused to carry the HARQ-ACK payload of a subsequent DL slot, thus increasing the efficiency of this decision.

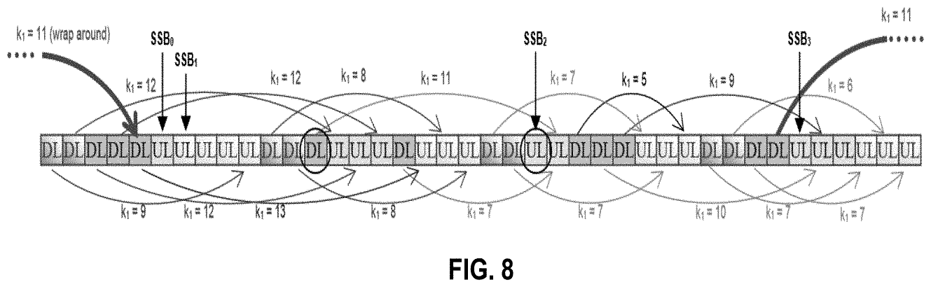

While selecting k₁ values, rules 6 and 7 are considered to ensure HARQ-ACK is not scheduled to overlap in symbols with SSBs, nor earlier than an already allocated HARQ-ACK resource. Besides, HARQ-ACK cannot be scheduled to overlap with UL data transmissions for which the UL DCI has been sent earlier than the DL DCI that is scheduling HARQ-ACK. The RAP generator 150 accounts for this, and in cases of a similar rate of DL and UL slots, this typically results on k₁ and k₂ values to be similar (see example and some exceptions in FIG. 8 below).

Also, pattern wrap-around will happen when getting close to the rightmost (i.e. last) slots in the pattern. In TDD, wrap-arounds will potentially need to modify existing DL allocations on flexible symbols of the PUCCH cell as explained above. In case the DL TDRA list does not include the required combination of DL symbols to perform the DL allocation modification on the target HARQ-ACK slot, a new entry to the list is attempted. If the list is already full, the DL allocation that was being modified is left as is, and the DL allocation in course is not scheduled (it is dropped, such slot is not used for DL).

To conclude Phase V, each new k₁ value that a cell requires to allocate HARQ-ACK resources is added to the dl-DataToUL-ACK list. If the list is full and there is no value in the dl-DataToUL-ACK list that can be reused, the DL allocation cannot be performed, so it is also dropped in this case (such slot is not used for DL).

FIG. 8 is a slot diagram for reference in describing an example of Phase V continuing from the previous example and a single cell. In this example, the RAP generator 150 started from leftmost DL slot and was allocating the HARQ-ACK resources favoring HARQ-ACK slots and then UL slots allowed by Rule 7 (i.e. the first UL slot whose DCI is not scheduled earlier than the DL DCI that is allocating the HARQ-ACK). At some point, the RAP generator 150 reaches the DL slot that is surrounded by a black circle in FIG. 8 and tries to allocate HARQ-ACK in the UL first UL slot that complies to Rule 7 (UL slot also in black circle). However, the semi-static HARQ-ACK RRC settings indicate that HARQ-ACK would overlap with SSB₂ symbols. A k₁ equals 11 is then used to target next slot (which is acceptable because the UL DCI for this UL slot will be scheduled later). Note the same UL slot will carry the HARQ-ACK of two DL slots (reusing already-allocated HARQ-ACK resources).

The situation repeats for a later DL slot, with HARQ-ACK overlapping with SSB₃ symbols, so instead of a k₁ of 9, the RAP generator 150 uses k₁ equals 10. By that time, note that 8 entries have been added to dl-DataToUL-ACK list (the maximum supported by 3GPP specs). For the example of FIG. 8, the 8 entries are (in order of addition) 9, 12, 13, 8, 11, 7, 5 and 10. The remaining DL slots will need to reuse these existing entries.

Complying with Rule 7 of not scheduling HARQ-ACK that overlaps with a UL slot scheduled on earlier UL DCI, k₁ of 7 is used by the RAP generator 150 until wrap-around is required. Note how last DL slot needs to use k₁ equals 11 to look for a valid slot. The only two UL slots that happen after wrap around and that are in reach of the available k₁ values (using k₁ equals to 12 or 13) have SSB₀ and SSB₁ colliding with the HARQ-ACK symbols. Following the procedure described earlier, given there is no other option, a flexible slot that allows the HARQ-ACK symbols to be transmitted is selected with the highest possible k₁ value. In this example, a value of kl equals to 11 means allocating HARQ-ACK in a flexible slot allocated for DL. The RAP generator 150 here attempts to modify the DL allocation on such slot and add the required DL TDRA entry if not present already. If the modification is possible it is performed together with the last DL allocation of the pattern.

Referring again to FIG. 5, the last Phase VI of the RAP generator 150 consists of compressing the output by grouping allocations having similar characteristics. For example, the procedure described above will result on one DL/UL allocation per slot flagged as DL/UL in Phase 3. During this last phase, allocations that are equal in terms of DL TDRA and kl (in the case of DL) or UL TDRA (in the case of UL) may be grouped together and a list of slots in which these repeated allocations may be built for each group.

Apart from the full throughput scenario described, the inventive concepts may be applied other scenarios that are based on 3GPP test cases for Radio Frequency Conformance. In these modes the embodiments will simply modify the RRC whole configuration and determine the resource allocation that 3GPP specifications indicate. The procedure would be much simpler in such case.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. While representative embodiments are disclosed herein, one of ordinary skill in the art appreciates that many variations that are in accordance with the present, teachings are possible and remain within the scope of the appended claim set. The invention therefore is not to be restricted except within the scope of the appended claims.

What is claimed is:

1. A computer-implemented method of generating a resource allocation pattern (RAP) of an orthogonal frequency division multiplexing (OFDM) signal transmitted between a base station comprised of N cells and a mobile device, where N is one or more, the OFDM signal transmitted in either a frequency domain duplex (FDD) mode or a time domain duplex (TDD) mode, the method comprising:
setting a time duration of the RAP;
retrieving a TDD uplink/downlink (UL/DL) configuration setting indicative of successive OFDM slots including DL-only slots, UL-only slots and flexible slots, and
processing the TDD UL/DL configuration to obtain an initial resource allocation pattern in which the TDD UL/DL configuration is repeated to match the set time duration of the RAP, and in which the flexible slots among the repeated TDD UL/DL configuration are set as DL slots or UL slots;
for each of the N cells, determining a set of UL resource allocations comprising downlink control information (DCI) and an offset to corresponding UL slots for the RAP; and
for each of the N cells, determining a set of DL allocations including DCI and Hybrid Automatic Repeat Request Acknowledgment (HARQ-ACK) resources for the RAP.

2. The computer-implemented method of claim 1, wherein the time duration of the RAP is set to a least common multiple of a synchronization signal block (SSB) periodicity and a period of the successive OFDM slots indicated by the TDD UL/DL configuration.

3. The computer-implemented method of claim 1, wherein the flexible slots among the repeated TDD UL/DL configuration are set as DL slots or UL slots according to a preset ratio of DL to UL slots.

4. The computer-implemented method of claim 1, wherein, in the TDD mode, processing the TDD UL/DL configuration to obtain initial resource allocation pattern includes allocating physical random access channel (PRACH) occasions to UL-only slots and flexible slots of the initial resource allocation pattern.

5. The computer-implemented method of claim 4, wherein the PRACH occasions are allocated such that a number of allocations to the flexible slots is minimized.

6. The computer-implemented method of claim 1, further comprising compressing the RAP by grouping allocations having similar characteristics.

7. The computer-implemented method of claim 1, wherein the base station is a network emulator configured to operate in compliance with Fifth Generation (5G) New Radio (NR) standards.

8. The computer-implemented method of claim 1, where N is at least two.

9. A non-transitory computer-readable storage medium comprising a computer program, the computer program when executed by a computer causing the computer to be responsive to user variable input settings to automatically generate a resource allocation pattern (RAP) of an orthogonal frequency division multiplexing (OFDM) signal transmitted between a base station comprised of N cells and a mobile device, where N is one or more, the OFDM signal transmitted in either a frequency domain duplex (FDD) mode or a time domain duplex (TDD) mode.

10. The non-transitory computer-readable storage medium of claim 9, wherein the computer program when executed by the computer executes a method comprising:
setting a time duration of the RAP;
retrieving a TDD uplink/downlink (UL/DL) configuration setting indicative of successive OFDM slots including DL-only slots, UL-only slots and flexible slots;
processing the TDD UL/DL configuration to obtain an initial resource allocation pattern in which the TDD UL/DL configuration is repeated to match the set time duration of the RAP, and in which the flexible slots among the repeated TDD UL/DL configuration are set as DL slots or UL slots;
for each of the N cells, determining a set of UL resource allocations comprising downlink control information (DCI) and an offset to corresponding UL slots for the RAP; and
for each of the N cells, determining a set of DL allocations including DCI and Hybrid Automatic Repeat Request Acknowledgment (HARQ-ACK) resources for the RAP.

11. The non-transitory computer-readable storage medium of claim 10, wherein, in the method, the time duration of the RAP is set to a least common multiple of a synchronization signal block (SSB) periodicity and a period of the successive OFDM slots indicated by the TDD UL/DL configuration.

12. The non-transitory computer-readable storage medium of claim 10, wherein, in the method, the flexible slots among the repeated TDD UL/DL configuration are set as DL slots or UL slots according to a preset ratio of DL to UL slots.

13. The non-transitory computer-readable storage medium of claim 10, wherein, in the TDD mode of the method, processing the TDD UL/DL configuration to obtain the initial resource allocation pattern includes allocating physical random access channel (PRACH) occasions to UL-only slots and flexible slots of the initial resource allocation pattern.

14. The non-transitory computer-readable storage medium of claim 13, wherein, in the method, the PRACH occasions are allocated such that a number of allocations to the flexible slots is minimized.

15. The non-transitory computer-readable storage medium of claim 10, the method further comprising compressing the RAP by grouping allocations having similar characteristics.

16. The non-transitory computer-readable storage medium of claim 9, wherein the storage medium is located in a network emulator configured to operate in compliance with Fifth Generation (5G) New Radio (NR) standards, and where N is at least two.

17. A Fifth Generation (5G) New Radio (NR) network emulator, comprising:
N cells configured to communicate with a mobile device using orthogonal frequency division multiplexing (OFDM) signal transmission, where N is one or more, the OFDM signal transmitted in either a frequency domain duplex (FDD) mode or a time domain duplex (TDD) mode; and
a resource allocation pattern (RAP) generator configured to generate a resource allocation pattern of signal slots of the OFDM signal for the N cells with reference to radio resource control (RRC) settings.

18. The 5GNR network emulator of claim 17, further comprising a user interface configured to set a plurality of user-definable resource allocation pattern parameters.

19. The 5GNR network emulator of claim 17, where N is at least two, and wherein the RAP generator is configured to:
set a time duration of the RAP;
retrieve a TDD uplink/downlink (UL/DL) configuration setting indicative of successive OFDM slots including DL-only slots, UL-only slots and flexible slots;
process the TDD UL/DL configuration to obtain an initial resource allocation pattern in which the TDD UL/DL configuration is repeated to match the set time duration of the RAP, and in which the flexible slots among the repeated TDD UL/DL configuration are set as DL slots or UL slots;
for each of the N cells, determine a set of UL resource allocations comprising downlink control information (DCI) and an offset to corresponding UL signals for the RAP; and
for each of the N cells, determine a set of DL allocations including DCI and Hybrid Automatic Repeat Request Acknowledgment (HARQ-ACK) resources for the RAP.

20. The 5GNR network emulator of claim 19, wherein the time duration of the RAP is set to a least common multiple of a synchronization signal block (SSB) periodicity and a period of the successive OFDM slots indicated by the TDD UL/DL configuration, and the flexible slots among the repeated TDD UL/DL configuration are set as DL slots or UL slots according to a preset ratio of DL to UL slots.
